(19) United States
(12) Patent Application Publication
(10) Pub. No.: US 2024/0241939 A1
(43) Pub. Date: Jul. 18, 2024

(54) AUDITING SECURE ENCLAVES

(71) Applicant: R3 Ltd., London (GB)

(72) Inventor: Rui Pedro Silva Marques de Almeida, London (GB)

(21) Appl. No.: 18/096,475

(22) Filed: Jan. 12, 2023

(51) Int. Cl. G06F 21/44; G06F 8/30

(52) U.S. Cl. CPC G06F 21/44; G06F 8/30

(57) ABSTRACT

An auditing system for secure enclaves executed in trusted execution environments accesses sets of source code instructions that are to be built at one or more host computing systems. For each of the sets of source code instructions, the auditing system builds an executable file. An enclave identifier is computed based on each of the executable files and stored in a data repository maintained by the auditing system. In response to receiving a request to authenticate a target secure enclave associated with an enclave identifier of the target secure enclave, the auditing system authenticates the target secure enclave based on a determined match between the enclave identifier of the target secure enclave and the stored enclave identifiers.

### BACKGROUND

Some application providers execute applications in trusted execution environments (TEEs) to, for example, ensure authenticity of an output of the application, protect privacy of data input to the application, or reduce the ability of other applications to tamper with the execution of the application. Such application programs executing in TEEs, which are each assigned to their own secure enclave, often need to validate their authenticity to a client device that is sending data to or receiving data from the secure enclave.

### BRIEF DESCRIPTION OF THE DRAWINGS

Detailed descriptions of implementations of the present invention will be described and explained through the use of the accompanying drawings.

FIG. 1 is a block diagram of a host computing system, according to some implementations.

FIG. 2 is a block diagram illustrating an environment in which third-party auditing of secure enclaves is performed, according to some implementations.

FIG. 3 is a block diagram illustrating example auditing systems.

FIG. 4 is an interaction diagram illustrating a process for auditing secure enclaves, according to some implementations.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

A secure enclave in a trusted execution environment typically has two identities. An enclave identity, represented by a value commonly referred to as MRENCLAVE, is a cryptographic hash of a build of the application code executed in an enclave. The enclave identity uniquely identifies a particular build or version of an enclave, such that different builds or versions of the same underlying application code have different enclave identities. The second identity of an enclave is a signing identity, typically referred to as MRSIGNER, which is provided by an authority to sign the enclave prior to its distribution. The signing identity is the same for all enclaves signed by the same authority. Client devices can request either the enclave identity or the signing identity, or both, in order to validate the application executing in the enclave. However, different builds of an enclave often result in different MRENCLAVE values because different compilers generate different binaries to represent the same application code, for example due to different random number generation, different heap allocation, and/or different garbage collection. Furthermore, when a compiler is running in a multi-thread environment, different loads on the system performing the compilation may cause even the same compiler to produce different binaries (e.g., because different threads might complete at different rates).

Since the enclave identity is different for different builds of an enclave, a client device may often incorrectly determine that an enclave is invalid if the authentication is performed solely based upon the enclave identity. On the other hand, the signing identity only identifies the signer of the application code. If authentication is performed based on the signing identity, data privacy and code validation is effectively delegated to the code signer without the benefits provided by the TEE.

To solve these problems, the inventors have conceived of and reduced to practice a system and process for auditing trusted execution environments in order to authenticate different builds of the same enclave. According to some implementations, an auditing system accesses a plurality of sets of source code instructions that are to be built at one or more host computing systems to generate executable files for execution in respective secure enclaves of the one or more host computing systems. Each executable file is represented by an associated enclave identifier. The auditing system generates, for each of the plurality of sets of source code instructions, one or more builds of a respective set of source code instructions. For each of the generated builds, the auditing system stores an enclave identifier representing the build. When a request is received to authenticate a target secure enclave, the auditing system authenticates the target secure enclave based on a determined match between an enclave identifier of the target secure enclave and the one or more stored enclave identifiers.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Trusted Execution Environment

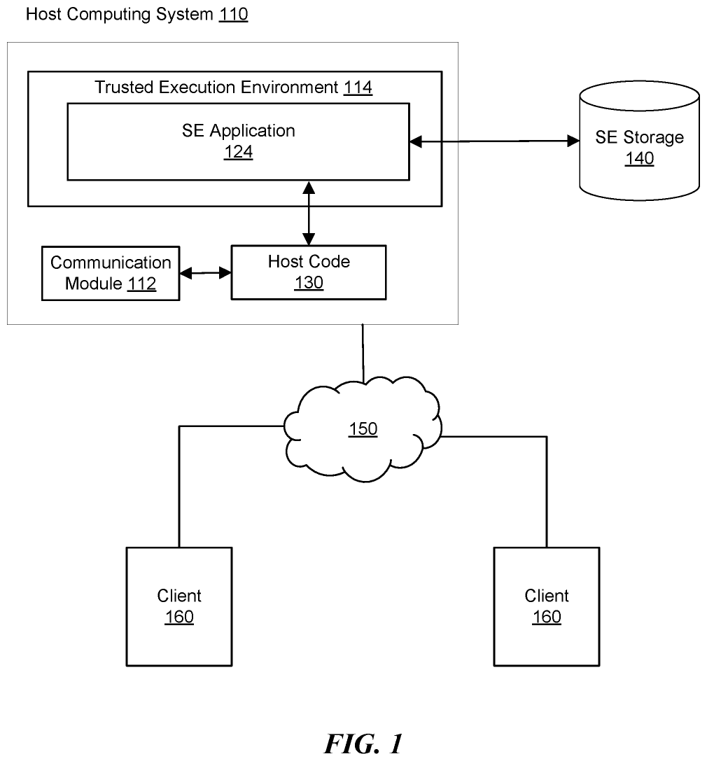

FIG. 1 is a block diagram of the host computing system 110, according to some implementations. As shown in in FIG. 1, the host computing system 110 includes a trusted execution environment (TEE) 114, a communication module 112, and host code 130.

The TEE 114, also referred to as a secure enclave, refers to a feature of a central processing unit (“CPU”) in which code and data of code (i.e., trusted code) are stored in memory in encrypted form and decrypted only when retrieved for use by the CPU. Such code is said to execute in the secure enclave. During manufacture, the secure enclave is provided a set of CPU private keys. The CPU private keys are stored in such a way that they cannot be altered in any way, including being deleted. The CPU supports generating an attestation of the trusted code that executes in the secure enclave. The attestation includes a hash of the trusted code, an identifier of the CPU, and application data. The attestation is signed by a CPU private key that is known to the manufacturer. A client can request the CPU to provide the attestation as evidence of the trusted code that executes in the secure enclave. The client can request a service of the manufacturer of the CPU to verify the signature. The client can then verify that the hash is a hash of the trusted code that the client expects. The attestation may also include a public key that the client can use to encrypt data that the secure enclave can decrypt using the corresponding private key. An example type of secure enclave that can be used by the host computing system 110 is that provided by the Software Guard Extensions (“SGX”) feature of Intel Corporation.

The TEE 114 creates a tamper-proof space for the code of a secure enclave (SE) application 124 to execute, so that other portions of the host computing system 110 (including the host code 130) cannot inspect or interfere with its execution. The TEE 114 protects data at rest (within the TEE), in motion (between the TEE and storage), and during computation (within the TEE). Before engaging with a TEE of another node, the TEE 114 can produce an attestation that it has been secured, is running the correct code of the application 124, and has not been tampered with. The code of the application 124 communicates with other nodes, such as the client 160, using encrypted messages, for example, encrypted transaction offers. The encryption may be based on public/private key pairs or symmetric keys of the application.

The TEE 114 can provide isolated tamper-proof enclaves for each of multiple SE applications 124 executed within the host computing system 110. For example, an enclave is managed for an SE application corresponding to each of a plurality of host applications executed by the host computing system 110, such that each of the plurality of host applications corresponds to a different, isolated enclave. The host computing system 110 maintains a record of all enclaves that have been created, for example in an enclave page cache (EPC). The EPC represents a subset of processor reserved memory (PRM), which cannot be directly accessed by other software within the host computing system 110 or by an external system. Each enclave can be allocated a pointer to its own memory area in a shared memory between the host application and the SE application 124 to reduce the ability of the host to pass information between enclaves using the shared memory.

An enclave further includes a certificate of the author of the enclave. The certificate is referred to as an Enclave Signature (SIGSTRUCT). The enclave signature includes an enclave measurement, the author's public key, a Security Version Number (ISVSVN) of the enclave, and a Product ID (ISVPRODID) of the enclave. The enclave signature is signed using the author's private key. The enclave measurement is a hash of the trusted code and its initial data. When the code is loaded into protected memory (EPC), the CPU calculates a measurement that is used as an enclave identifier and stores the measurement in an MRENCLAVE register. If the calculated measurement is not equal to the enclave measurement, the CPU will not allow the enclave to be initialized within the TEE. After the enclave is initialized, the CPU stores a hash of the author's public key in a MRSIGNER register as an identifier of the author. The ISVSVN specifies the security level of the enclave. The ISVPRODID identifies the product the enclave represents. The CPU records both the ISVSVN and ISVPRODID.

A client 160 that is to interact with an enclave may require the TEE to “attest” to the trusted code and data of the enclave. To provide an attestation to a client that may be executing on a platform that is different from the platform of the CPU that is executing the enclave (referred to as “remote” attestation), the TEE 114 generates a “report” that includes the enclave identifier (MRENCLAVE), hash of the author's public key (MRSIGNER), attributes of the enclave, and user data of the enclave. The report is passed to a quoting enclave (QE) to verify and sign the report. When verified, the QE generates a “quote” that includes the report and a signature of the TEE. The quote is then sent to the client 160.

Upon receiving a quote, the client 160 can verify the signature and, if verified, ensure that the report represents the trusted code that the client expects. The signature may be based on an Enhanced Privacy ID (EPID) in which different TEEs have different private keys, but signatures based on those private keys can be verified using the same public key. The client may invoke the services of an EPID verification service to verify a signature on a quote.

An enclave that is to interact with another enclave that is executing on the same platform may want the other enclave to attest to its trusted code and data. In such a case, a simplified version of attestation can be used (referred to as “local” attestation). To initiate an attestation, the requesting enclave send its MRENCLAVE measurement to an attesting enclave. The attesting enclave requests the CPU to generate a report destined to the requesting enclave identified by the MRENCLAVE measurement that it received and sends the report to the requesting enclave. The requesting enclave then asks the CPU to verify the report. The attesting enclave may request the requesting enclave to provide an attestation to affect a mutual attestation.

A TEE 114 provides support for an enclave to encrypt data that is to be stored outside of the TEE and to decrypt the encrypted data when it is later retrieved into the TEE. This encrypting and decrypting is referred to as “sealing” and “unsealing.” The TEE 114 generates an encryption key and a decryption key based on a “fused key” that is not known outside of the hardware. The fused key is fused into the CPU hardware during the manufacturing process of the CPU, is not known outside of the CPU not even by the manufacturer, is unique to the CPU, and cannot be accessed except by the hardware. Upon request, the CPU generates a sealing key and unsealing key (e.g., public/private keypair) that is based on the fused key and data associated with the requesting enclave. Thus, each sealing key and unsealing key is unique to the CPU because the fuse keys are unique.

The CPU can generate two types of keys based on the associated data of the enclave that is used when generating the keys. The associated data is the MRENCLAVE (referred to as “sealing to the enclave”) or the combination of the MRSIGNER, ISVSVN, and ISVPRODID (referred to as “sealing to the author”). Data that is sealed to the enclave can only be unsealed by an enclave with the same MRENCLAVE value that is executing on the same CPU (i.e., using the same fused key) that generated the sealing key. Data that is sealed to the author can be unsealed by any enclave (e.g., different trusted code) of the author that has the same ISVPRODID and the same or an earlier ISVSVN (specified in a request to seal or unseal) and that is executing on the same CPU (i.e., using the same fused key) that generated the sealing key. (Note: The CPU will not generate seal-to-the-author keys for an ISVSVN that is greater than the ISVSVN of the enclave, which allows for only backward compatibility of sealing.) The TEE 114 provides a seal application programming interface (API) for sealing data and an unseal API for unsealing data.

The host code 130 represents untrusted code that executes outside of the TEE 114. The host code 130 is configured to interface or communicate with external systems, such as the clients 160, to pass data between the external systems and the TEE 114. For example, the host code 130 receives encrypted client data from the client systems 160 and encrypted application data (e.g., emails) from the SE storage 140 and provides the encrypted data to the SE application 124. The host code 130 can also receive encrypted application data from the SE application 124 and store the encrypted application data to the SE storage 140.

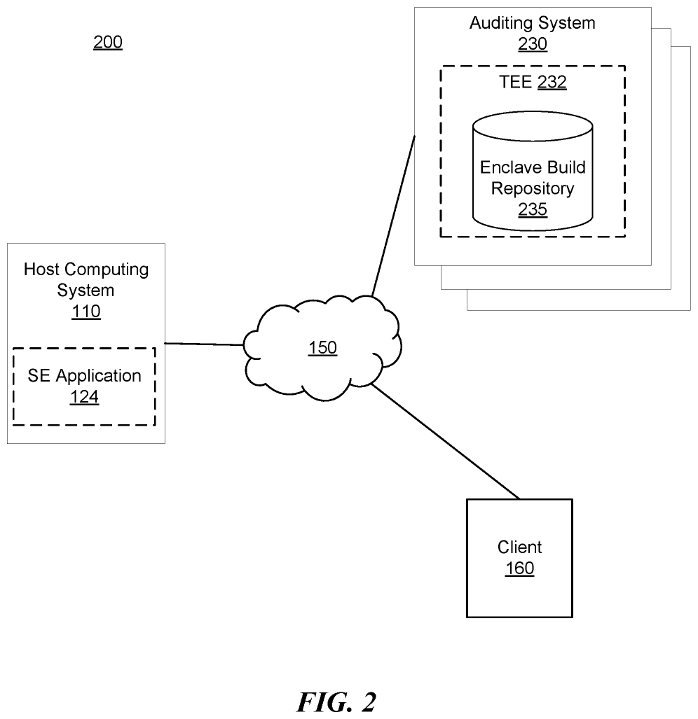

In addition to or instead of requiring a TEE to attest to the code executed in a secure enclave, the client 160 or a local application (such as the host code 130 or another SE application) may request a third-party audit of the enclave identifier. A third-party auditor is described with respect to FIG. 2.

FIG. 2 is a block diagram illustrating an environment 200 in which third-party auditing of secure enclaves is performed. As shown in FIG. 2, the environment 200 includes the host computing system 110, one or more client devices 160, and one or more auditing systems 230. Communications between the host computing system 110, client device(s) 160, and auditing system(s) 230 can be enabled by a network 150, such as the Internet. Other implementations of the environment 200 can include additional systems or can distribute functionality differently among the systems.

The client device 160 interacts with the host computing system 110 to use one or more secure applications executed by the host system. Any of a variety of types of applications can use secure enclaves to ensure data privacy or when a tamper-proof environment is helpful to validate the authenticity of the application's output. For example, companies that sell commodities may send pricing information to an organization that publishes commodity indices. When a message with pricing information for a commodity is received by the organization, a secure enclave application operated by the organization stores the pricing information in an encrypted form and persistently in storage. The secure enclave application then retrieves the pricing information from storage, decrypts the pricing information, and calculates an index that is provided to a client device 160. To ensure the organization is executing the correct secure application (and thus to ensure that the calculated index is correct or that the applicable pricing data is secure), the client device 160 sends an audit request to the auditing systems 230.

The auditing systems 230 audit secure enclave applications to validate the instructions executed in an enclave. In some implementations, the auditing system 230 builds different versions of an enclave to be audited to create a set of binary files that represent the same enclave. For example, the auditing system 230 compiles a set of instructions to be executed in an enclave using different compilers or under different scenarios (e.g., under different system load conditions that cause threads to be completed in different orders in multi-thread environments). The auditing system 230 stores a hash value representing each binary (e.g., an MRENCLAVE value) in an enclave build repository 235. When a client 160 requests an audit of a host computing system's enclave, the auditing system 230 can compare a hash value of the build generated by the host computing system 110 to the set of hashes maintained in the enclave build repository 235. The auditing system 230 outputs an audit response to indicate whether the hash received from the host computing system matches one of the stored hash values.

In some implementations, a host computing system provides an auditing system 230 with information about the circumstances under which a particular secure enclave application was built (such as providing an identifier of the compiler used to build the enclave), enabling the auditing system 230 to recreate the build process and thereby validate the corresponding secure enclave.

In other implementations, the auditing system 230 disassembles a binary file received from the host computing system 110 to compare the disassembled instructions to the source code that is expected to be executed in an enclave. The auditing system 230 can automatically compare the disassembled instructions to expected source code to determine if the disassembled instructions match the expected source code. A match can be identified when the disassembled instructions have at least a threshold similarity to the expected source code or have at least a threshold similarity to specified portions of the expected source code, for example. Additionally or alternatively, the auditing system 230 includes a tool that matches disassembled instructions to source code for review by a human reviewer and outputs the matching for display to the reviewer. The tool can highlight disassembled instructions that do not have at least a threshold similarity to corresponding source code instructions to assist the reviewer in determining whether the disassembled instructions match the expected source code. The reviewer can then provide feedback to the auditing system 230 to indicate whether the disassembled instructions are a match.

If a disassembled binary file is found to match a set of source code expected to be executed in an enclave, the auditing system 230 stores an identifier of the binary file (e.g., an MRENCLAVE value) in the enclave build repository 235.

In some implementations, a comparison of disassembled instructions to expected source code is performed by a system other than the auditing system 230. For example, the client 160 can access the tool to disassemble code and generate a comparison between the disassembled code and the expected source code. A user of the client 160 can then analyze the outputs of the tool to determine whether to trust the code executed in the relevant secure enclave.

Each auditing system 230 can include a trusted execution environment 232 in which to build enclaves or perform comparisons between host computing system enclaves and the build versions produced by the auditing system 230. For example, when auditing an enclave of a host computing system, a secure enclave executed within the TEE 232 issues a query to a repository that stores built enclave identifiers. When the TEE 232 secure enclave receives a response to the query, it compares the enclave identifier in the received auditing request to the enclave identifier returned in response to the query. The TEE 232 can include similar functionality to the TEE 114 of the host computing system 110. Thus, the instructions executed by an auditing system 230 to build enclaves or produce audit results can themselves be audited by other auditing systems 230 in manners similar to that described herein for host computing system enclaves. Similarly, the TEE 232 can attest to its authenticity in manners similar to that described above for the host system's secure enclaves. For example, an enclave within the TEE 232 sends a client device a signer identifier to indicate an entity that signed the enclave. If the client device validates the signer identity, the client device requests an audit from the TEE 232 of the host system enclave.

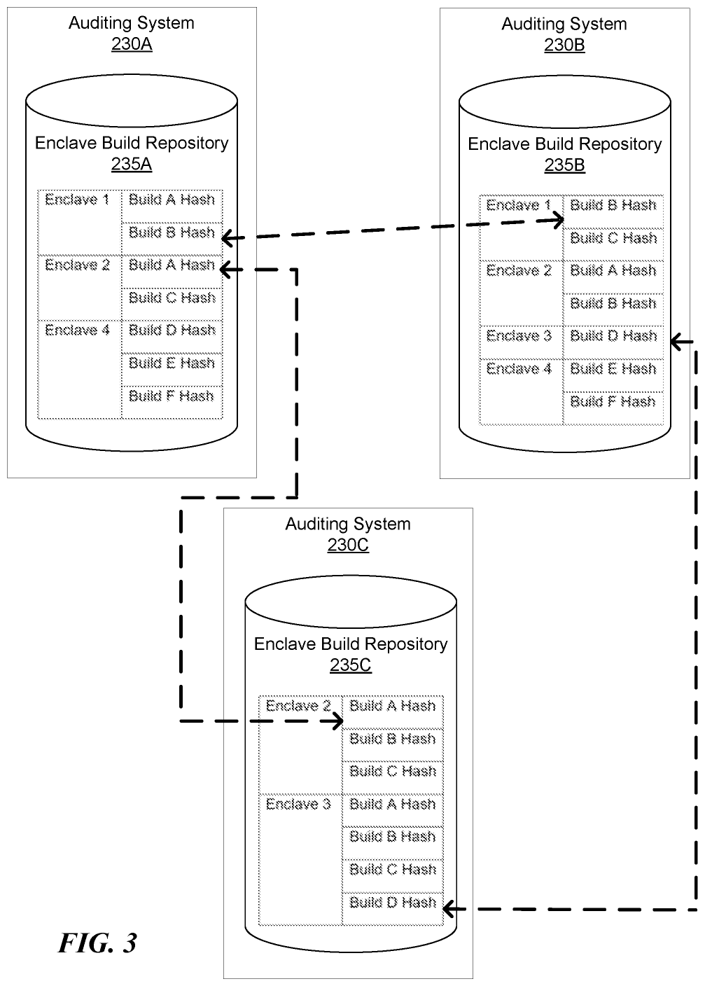

FIG. 3 is a block diagram illustrating example auditing systems 230. As shown in FIG. 3, the environment 200 described with respect to FIG. 2 can include multiple auditing system 230 (such as a first auditing system 230A, a second auditing system 230B, and a third auditing system 230C). Each of the auditing system 230A, 230B, 230C maintains a respective enclave build repository 235A, 235B, 235C. As each of the auditing systems 230 may analyze different enclaves, each repository 235 may include different build versions for different enclaves. Each auditing system 230 can also build different versions of an enclave used on another auditing system.

When a client requests validation of an enclave, the client may send the request to a particular auditing system 230, such as an auditing system that is trusted by the client. Alternatively, requests may be received at a load balancing system that directs the query to any of the auditing systems 230. In still other implementations, a centralized auditing system receives incoming client requests and queries any linked auditing systems on behalf of the clients.

If the client requests an audit of a target secure enclave from a particular auditing system 230, such as the auditing system 230A, the particular system 230A may not have an identifier for a corresponding build of the target secure enclave even though the target secure enclave is authentic. In some implementations, the auditing system 230A queries the other auditing systems 230 before returning a result to the client to indicate that the target secure enclave fails validation. If, in response to the query, it is determined that the auditing system 230B or 230C has an enclave identifier that matches the identifier of the target secure enclave, the auditing system 230A can add the identifier to its enclave build repository 235A.

In some implementations, queries to a particular auditing system 230 (such as the system 230A) are audited by one or more other auditing systems. For example, if a client 160 sends a request to auditing system 230A to audit the “Build B Hash” of “Enclave 1,” the auditing system 230A validates its stored enclave identifier against the “Build B Hash of Enclave 1” stored at the auditing system 230B before returning a validation result to the client.

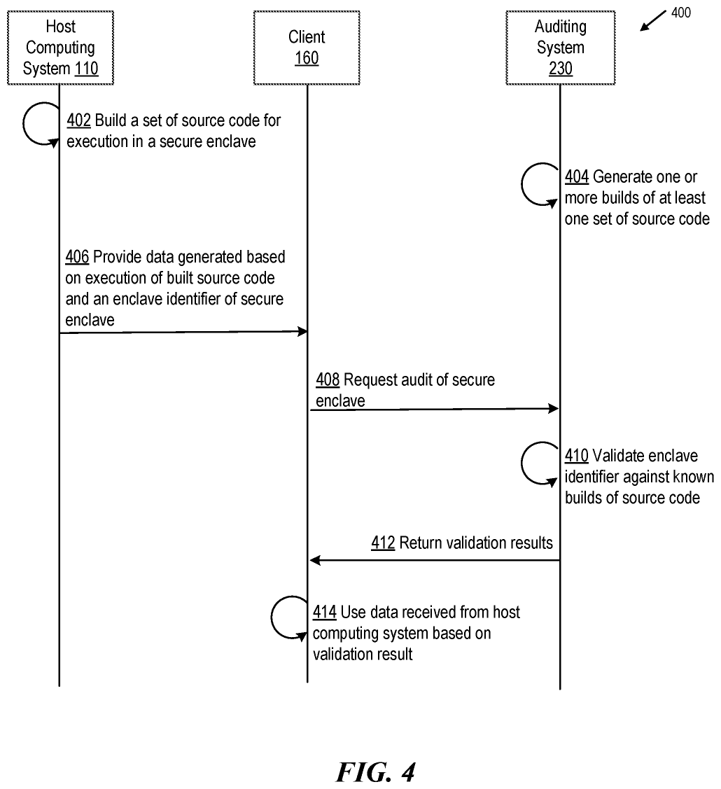

FIG. 4 is an interaction diagram illustrating a process 400 for auditing secure enclaves, according to some implementations. As shown in FIG. 4, the process 400 can include interactions between the host computing system 110, the client 160, and one or more auditing systems 230. Other implementations of the process 400 include additional, fewer, or different steps, or perform the steps in different orders. Furthermore, in other implementations, the steps can be performed by different entities than illustrated in FIG. 4. For example, while FIG. 4 illustrates a client 160 that receives data from a secure enclave application executing on the host computing system 110 and requests auditing of the secure enclave, other implementations of the process 400 do not include the client 160. Instead, another secure enclave or untrusted code on the host computing system 110 can request auditing of a target secure enclave, for example.

As shown in FIG. 4, the host computing system 110 builds a set of source code for execution in a secure enclave at step 402. For example, the host computing system 110 compiles the source code into object code, links libraries, packages an executable file, and/or causes a trusted execution environment to sign the executable file (e.g., using an MRSIGNER or MRENCLAVE) value. The output of the build process is an executable file associated with an enclave identifier (e.g., MRENCLAVE) and a signing identifier (e.g., MRSIGNER)

At step 404, the auditing system 230 generates one or more builds of at least one set of source code. The auditing system 230 can generate different builds of the same source code, for example using different compilers or under different circumstances to generate different executable files that each represent a build of the same source code. For each build, the auditing system 230 generates and stores an enclave identifier (e.g., by computing a hash value that represents a binary file produced by the build).

At step 406, the host computing system 110 provides a client 160 with data generated based on execution of an executable file output by the build process. In addition to sending the data, the host computing system 110 sends the client 160 an enclave identifier (e.g., an MRENCLAVE value) associated with the executable file.

At step 408, the client 160 sends a request to the auditing system 230 to audit the secure enclave that produced the received data. The audit request includes the enclave identifier received from the host computing system 110. In some cases, as described for example with respect to FIG. 3, multiple auditing systems 230 may be available to handle the client's audit request. In these cases, the auditing system 230 to which the client 160 sends the audit request can be configurable within a policy at the client 160 (e.g., to specify an auditing system that is trusted by an administrator or user of the client). Alternatively, the client 160 sends the audit request to a bank of auditing systems 230 that together query enclave build databases and validate each other's query results. Furthermore, in some implementations, the client 160 first queries the auditing system 230 for information about a secure enclave at the auditing system 230 to attest to authenticity of the auditing system's enclave prior to sending data to the auditing system 230. For example, the client requests an MRENCLAVE and/or MRSIGNER from the auditing system. The client 160 validates the received value and transmits the request to audit a target secure enclave in response to successful validation.

At step 410, the auditing system 230 validates the enclave identifier against known builds of the source code that is expected to be executed by the secure enclave. In some implementations, the auditing system 230 queries a data repository maintained by the auditing system, which includes enclave identifiers of enclaves built by the auditing system 230 or built by other trusted auditing systems. In some implementations, if the auditing system's own data repository does not include an enclave identifier that matches the enclave identifier received from the client, the auditing system 230 queries other auditing systems' data repositories. The auditing system 230 can also request attestation of the other auditing systems or audit the other auditing systems, in order to certify validity of any enclave builds by the other auditing systems.

At step 412, the auditing system 230 returns a validation result to the client 160, indicating whether the target enclave was found to be valid or not found to be valid. Accompanying the validation result can be an authentication of the auditing system 230. For example, in implementations where the auditing system 230 stores an enclave build repository in secure enclave storage or performs at least part of the auditing process within a secure enclave, the auditing system 230 returns a validation result that includes an enclave identifier and/or a signer identifier associated with the auditing system's secure enclave. In another example, a first auditing system 230 requests auditing of its secure enclave by a second auditing system, and returns a validation result produced by the second auditing system.

At step 414, the client 160 uses the data received from the host computing system based on the validation result. For example, if the validation result indicates the secure enclave is not executing the correct application code, the client 160 discards any data received from the secure enclave, does not send any private data to the secure enclave for processing, and/or requests data from a different secure enclave.

### Computer System

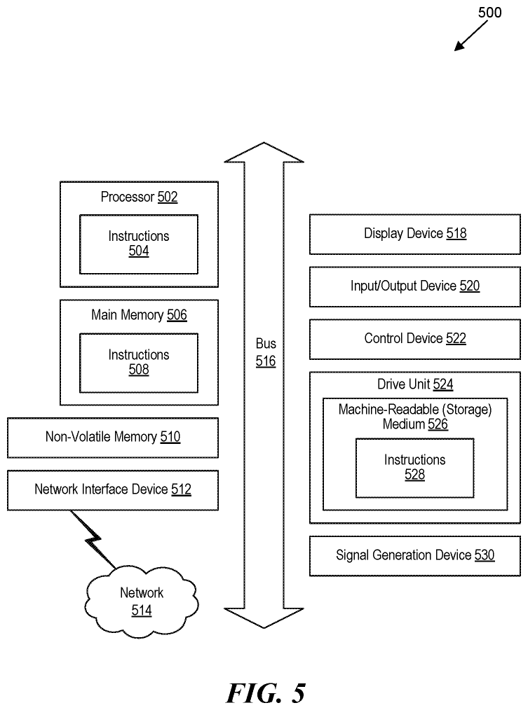

FIG. 5 is a block diagram that illustrates an example of a computer system 500 in which at least some operations described herein can be implemented. For example, the computer system 500 can implement the host computing system 110, a client device 160, and/or an auditing system 230. As shown, the computer system 500 can include: one or more processors 502, main memory 506, non-volatile memory 510, a network interface device 512, video display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementation, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### REMARKS

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

We claim:

1. A system comprising:
at least one hardware processor; and
at least one non-transitory memory storing instructions, which, when executed by the at least one hardware processor, cause the system to:
access a plurality of sets of source code instructions that are to be built at one or more host computing systems to generate respective binary files that are executable in respective secure enclaves of the one or more host computing systems,
wherein each set of source code instructions is represented by an associated hash value computed based on a corresponding binary file produced from a build of the set of source code instructions at the one or more host computing systems;
generate, for each of the plurality of sets of source code instructions, one or more binary files that each represents a build of a respective set of source code instructions;
compute, for each of the generated binary files, a hash value representing the generated binary file;
store the computed hash values in a data repository associated with the system;
receive a request from a client to authenticate a target secure enclave, wherein the request identifies a hash value identifying the target secure enclave; and
authenticate the target secure enclave based on a determined match between the hash value identifying the target secure enclave and one of the computed hash values, representing the generated binary files, stored in the data repository.

2. The system of claim 1, wherein generating the one or more binary files for the respective set of source code instructions comprises producing one or more sets of compiled instructions based on the respective set of source code instructions using each of multiple different compilers.

3. The system of claim 1, wherein generating the one or more binary files for the respective set of source code instructions comprises producing one or more sets of compiled instructions by the one or more processors when different processing loads are applied to the one or more processors.

4. The system of claim 1, wherein authenticating the target secure enclave comprises:
issuing a query from a secure enclave associated with the system to the data repository; and
process, in the secure enclave associated with the system, the hash value in the request against a query response received in response to the issued query.

5. The system of claim 4, wherein the instructions when executed further cause the one or more processors to:
transmit, to the client, a signer identifier identifying an entity that signed the secure enclave associated with the system,
wherein the client is configured to validate the signer identifier and transmit the request to authenticate the target secure enclave in response to validating the signer identifier.

6. The system of claim 1, wherein storing the hash value for each of the generated builds comprises storing each of the hash values in a repository maintained by a secure enclave associated with the system.

7. The system of claim 1, wherein the one or more builds are generated in a secure enclave associated with the system.

8. A computer-readable storage medium, excluding transitory signals and storing instructions, which, when executed by at least one data processor of a system, cause the system to:
access a plurality of sets of source code instructions that are to be built at one or more host computing systems to generate executable files for execution in respective secure enclaves of the one or more host computing systems,
wherein each executable file is represented by an associated enclave identifier;
generate, for each of the plurality of sets of source code instructions, one or more builds of a respective set of source code instructions;
store, for each of the generated builds, an enclave identifier representing the build;
receive a request to authenticate a target secure enclave associated with an enclave identifier of the target secure enclave; and
authenticate the target secure enclave based on a determined match between the enclave identifier of the target secure enclave and the stored enclave identifiers.

9. The computer readable storage medium of claim 8, wherein generating the one or more builds of the respective set of source code instructions comprises producing one or more sets of compiled instructions based on the respective set of source code instructions using each of multiple different compilers.

10. The computer readable storage medium of claim 8, wherein generating the one or more builds of the respective set of source code instructions comprises producing one or more sets of compiled instructions by the one or more processors when different processing loads are applied to the one or more processors.

11. The computer readable storage medium of claim 8, wherein authenticating the target secure enclave comprises:
issuing a query from an auditing system secure enclave to a repository storing the enclave identifier representing each of the generated builds; and
process, in the auditing system secure enclave, the enclave identifier of the target secure enclave against a query response received in response to the issued query.

12. The computer readable storage medium of claim 11, wherein the instructions when executed further cause the one or more processors to:
receive a request from a system to attest to authenticity of the auditing system secure enclave; and
transmit, to the system, a signer identifier identifying an entity that signed the auditing system secure enclave,
wherein the system is configured to validate the signer identifier and transmit the request to authenticate the target secure enclave in response to validating the signer identifier.

13. The computer readable storage medium of claim 8, wherein storing the enclave identifier for each of the generated builds comprises storing each of the enclave identifiers in a repository maintained by an auditing system secure enclave.

14. The computer readable storage medium of claim 8, wherein the one or more builds are generated in an auditing system secure enclave.

15. The computer-readable storage medium of claim 8, wherein the request to authenticate the target secure enclave is received from a client.

16. The computer-readable storage medium of claim 8, wherein the target secure enclave is executed by a host computing system, and wherein the request to authenticate the target secure enclave is received from a second secure enclave executed by the host computing system.

17. A method for auditing secure enclaves executing on host computing systems, the method comprising:
accessing a plurality of sets of source code instructions that are to be built at one or more host computing systems to generate executable files for execution in respective secure enclaves of the one or more host computing systems,
wherein each executable file is represented by an associated enclave identifier;
generating, for each of the plurality of sets of source code instructions, one or more builds of a respective set of source code instructions;
storing, for each of the generated builds, an enclave identifier representing the build; and
in response to receiving a request to authenticate a target secure enclave associated with an enclave identifier of the target secure enclave, authenticating the target secure enclave based on a determined match between the enclave identifier of the target secure enclave and the stored enclave identifiers.

18. The method of claim 17, wherein generating the one or more builds of the respective set of source code instructions comprises producing one or more sets of compiled instructions based on the respective set of source code instructions using each of multiple different compilers.

19. The method of claim 17, wherein authenticating the target secure enclave comprises:
issuing a query from an auditing system secure enclave to a repository storing the enclave identifier representing each of the generated builds; and
process, in the auditing system secure enclave, the enclave identifier of the target secure enclave against a query response received in response to the issued query.

20. The method of claim 19, further comprising:
receiving a request from a system to attest to authenticity of the auditing system secure enclave; and
transmitting, to the system, a signer identifier identifying an entity that signed the auditing system secure enclave,
wherein the system is configured to validate the signer identifier and transmit the request to authenticate the target secure enclave in response to validating the signer identifier.
